(19) United States
(12) Patent Application Publication
(10) Pub. No.: US 2017/0156338 A1
(43) Pub. Date: Jun. 8, 2017

(54) COMPOSITE POWDER, HYBRID MATERIAL THEREOF, AND COMPOSITE THIN FILM THEREOF

(71) Applicant: National Taiwan University of Science and Technolo Technology, Taipei (TW)

(72) Inventors: Dong-Hau Kuo, Taipei (TW); Fu-An Yu, Taipei (TW); Yen-Rong Kuo, Taipei (TW); Yi-Yuan Yang, Taipei (TW); Jiunn-Yih Lee, Taipei (TW); Kuo-Pin Cheng, Taipei (TW); Chang-Mou Wu, Taipei (TW); Meng-Wei Ma, Taipei (TW); Kuan-Ting Chuang, Taipei (TW)

(21) Appl. No.: 15/065,884

(22) Filed: Mar. 10, 2016

(30) Foreign Application Priority Data
Dec. 7, 2015 (TW) 104140902

(51) Int. Cl. A01N 59/16; B01J 23/06; B01J 23/50; A01N 25/12; B01J 35/02; B01J 31/06; B01J 31/26; B01J 35/00; B01J 21/04

(52) U.S. Cl. CPC A01N 59/16; B01J 35/004; B01J 35/0033; B01J 23/06; B01J 23/50; B01J 21/04; B01J 35/026; B01J 35/0013; B01J 31/06; B01J 31/26; A01N 25/12; B01J 2231/005; B01J 2531/002

(57) ABSTRACT

Provided is a composite powder used for the visible light catalytic and anti-bacterial purposes. The composite powder includes a plurality of N-type semiconductor particles and a plurality of P-type semiconductor nano-particles. The P-type semiconductor nano-particles cover surfaces of the N-type semiconductor particles respectively. A weight ratio of the N-type semiconductor particles and the P-type semiconductor nano-particles is in a range of 1:0.1 to 1:0.5. A PN junction is provided between each of the N-type semiconductor particles and the corresponding P-type semiconductor nano-particles.

### CROSS-REFERENCE TO RELATED APPLICATION

This application claims the priority benefit of Taiwan application serial no. 104140902, filed on Dec. 7, 2015. The entirety of the above-mentioned patent application is hereby incorporated by reference herein and made a part of this specification.

### BACKGROUND OF THE INVENTION

Field of the Invention

The invention relates to a powder and an application thereof, and particularly to a composite powder, a hybrid material thereof, and a composite thin film thereof used for the visible light catalytic and anti-bacterial purposes.

Description of Related Art

A “photocatalyst” is a special catalyst. The photocatalyst may jump from valence band to conduction band by absorbing energy of light, and the place where an original electron exists appears an electric hole with positive electricity. That is a photogenerated electron or a photogenerated hole. Since such electron and hole has a stronger reduction and oxidation respectively, the reactant may proceed a chemical reaction to promote degradation, synthesis, and anti-bacteria of organic compounds. The above-mentioned process is called as a “photocatalytic reaction”.

Most of photocatalysts proceed a reaction under ultraviolet light nowadays. However, in the distribution of sunlight source, only about 5 percentage of whole solar energy is ultraviolet light. Thus, the efficiency of the usage of solar energy of such photocatalyst is very low, especially in a region without direct irradiation, a content of ultraviolet light thereof is lower. In addition, a content of ultraviolet light is very low in the light source in indoor environments. Also, ultraviolet light is harmful for human to induce skin diseases.

Currently, the industry is working on the study of the composite material having a photocatalytic characteristic with visible light irradiation and having an anti-bacterial ability without light irradiation simultaneously. The development of such material may make the photocatalyst toward to the inevitable trend of utility.

### SUMMARY OF THE INVENTION

The invention provides a composite powder with a PN junction, a hybrid material thereof, and a composite thin film thereof used for the visible light catalytic and anti-bacterial purposes.

The invention also provides a composite powder used for degradation of a surrogate of chemical warfare agents so as to convert into a substance without toxicity.

The invention provides a composite powder used for the visible light catalytic and anti-bacterial purposes. The composite powder includes a plurality of N-type semiconductor particles and a plurality of P-type semiconductor nano-particles. The P-type semiconductor nano-particles cover surfaces of the N-type semiconductor particles respectively. A weight ratio of the N-type semiconductor particles and the P-type semiconductor nano-particles is in a range of 1:0.1 to 1:0.5. A PN junction is provided between each of the N-type semiconductor particles and the corresponding P-type semiconductor nano-particles.

According to an embodiment of the invention, a material of the N-type semiconductor particles comprises zinc oxide, and a material of the P-type semiconductor nano-particles comprises silver oxide.

According to an embodiment of the invention, a particle size of the N-type semiconductor particles is in a range of 0.1 μm to 5 μm, and a particle size of the P-type semiconductor nano-particles is in a range of 1 nm to 50 nm.

According to an embodiment of the invention, the P-type semiconductor nano-particles are uniformly distributed on the surfaces of the N-type semiconductor particles.

The invention provides a composite thin film used for the visible light catalytic and anti-bacterial purposes. The composite thin film includes the composite powder, wherein the composite thin film is formed on surfaces of a substrate from the composite powder by a sputtering process.

The invention provides a hybrid material used for the visible light catalytic and anti-bacterial purposes. The hybrid material comprises a polymer material and the composite powder. The composite powder is uniformly mixed with the polymer material.

According to an embodiment of the invention, the hybrid material covers a surface of a substrate or mixes within the substrate.

According to an embodiment of the invention, the polymer material comprises a thermoplastic resin material, a thermosetting resin material, or a combination thereof.

The invention also provides a composite powder used for the purpose of degradation of a surrogate of chemical warfare agents. The composite powder includes a plurality of support particles of alumina or zinc oxide and a plurality of silver oxide nano-particles. The silver oxide nano-particles cover surfaces of the support particles respectively. A weight ratio of the support particles and the silver oxide nano-particles covers a range from a low silver oxide ratio of 1:0.01 increasingly to pure silver oxide.

According to an embodiment of the invention, the surrogate includes 2-chloroethyl ethyl sulfide (2-CEES).

Based on the above description, in the composite material (including powders or thin films) of the invention, the N-type ZnO semiconductor particles in sub-micrometer size are covered by the P-type Ag₂O semiconductor nano-particles in nanometer size to form the composite material with the PN junction. Thus, the ZnO/Ag₂O composite material of the invention has an anti-bacterial ability without light irradiation, while the ZnO/Ag₂O composite material of the invention has high photocatalytic ability and an advanced anti-bacterial ability under visible light irradiation. Therefore, the ZnO/Ag₂O composite material of the invention may be applied in a variety of substrates to avoid vectors breeding. At the same time, the harmful organic substance in air may be continuously absorbed and degraded to achieve the effect of air purification.

In addition, the composite material of the invention may be mixed with the polymer material to form the hybrid material which has a photocatalytic characteristic and an anti-bacterial ability simultaneously. Besides, the invention also provides the Ag₂O/Al₂O₃ and ZnO/Ag₂O composite powders used for the purpose of degradation of a surrogate of chemical warfare agents, so that a threat of chemical war is reduced.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a composite powder according to an embodiment of the invention.

FIG. 2 is a curve diagram illustrating a dye decomposition ratio versus time of the composite powders of Examples 1-5 and Comparative Examples 1-2 under visible light irradiation.

FIG. 3 is a picture illustrating a LB agar of the ZnO/Ag₂O mixed solution with E. coli of Example 6 after different irradiation times of visible light.

FIG. 4 is a picture illustrating a LB agar of the ZnO/Ag₂O mixed solution with E. coli of Example 7 in a dark room in different times.

FIG. 5 is a picture illustrating the ZnO/Ag₂O composite thin film coated on fabrics.

FIG. 6 is a picture illustrating a LB agar of the hybrid film solution with E. coli of Example 8 under visible light irradiation in different times.

FIG. 7 is a picture illustrating a LB agar of the hybrid film solution with E. coli of Example 9 in a dark room in different times.

FIG. 8 is a picture illustrating a LB agar of the hybrid film solution with E. coli of Example 10 under visible light irradiation in different times.

FIG. 9 is a picture illustrating a LB agar of the hybrid film solution with E. coli of Example 11 in a dark room in different times.

FIG. 10 is a view illustrating a concentration of Ag or Ag₂O of the composite powder versus a conversion percentage of the toxic chemical of 2-CEES of Examples 12-13 and Comparative Examples 3-4 in 15 minutes.

FIG. 11 is a view illustrating a concentration of Ag₂O of the composite powder versus a conversion percentage of the toxic chemical of 2-CEES of Examples 1-3 and Comparative Examples 1-2 in 15 minutes under fluorescent room lamp and in a dark condition.

### DESCRIPTION OF THE EMBODIMENTS

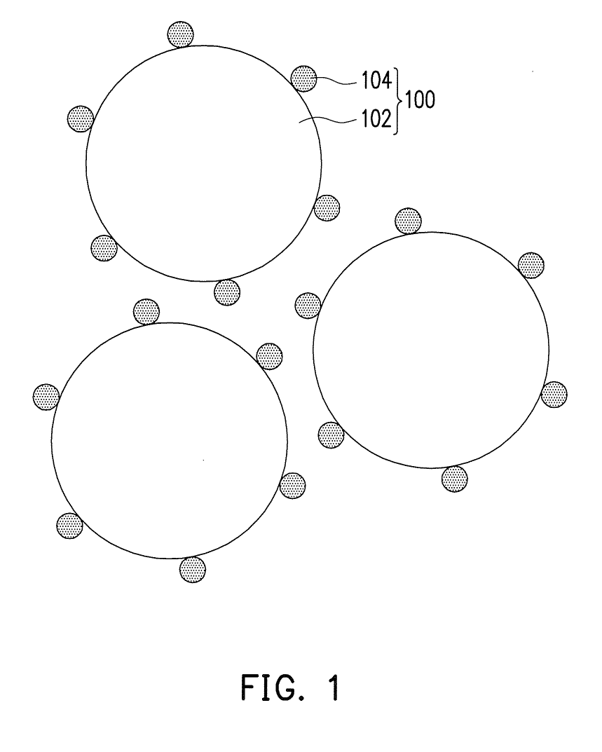

FIG. 1 is a schematic cross-sectional view illustrating a composite powder according to an embodiment of the invention.

Referring to FIG. 1, a composite powder 100 includes a plurality of N-type semiconductor particles 102 and a plurality of P-type semiconductor nano-particles 104 of the embodiment. The P-type semiconductor nano-particles 104 uniformly and discontinuously cover surfaces of the N-type semiconductor particles 102. However, the invention is not limited thereto, as long as the P-type semiconductor nano-particles 104 incompletely cover the surfaces of the N-type semiconductor particles 102 which is included within the scope of the invention. In an embodiment, a weight ratio of the N-type semiconductor particles 102 and the P-type semiconductor nano-particles 104 may be in a range of 1:0.1 to 1:0.5. A particle size of the N-type semiconductor particles 102 may be in a range of 0.1 μm to 5 μm. A particle size of the P-type semiconductor nano-particles 104 may be in a range of 1 nm to 50 nm. In an embodiment, a material of the N-type semiconductor particles 102 may be zinc oxide, for example. A material of the P-type semiconductor nano-particles 104 may be silver oxide, for example.

It should be noted that a PN junction is provided between each of the N-type semiconductor particles 102 and the corresponding P-type semiconductor nano-particles 104. In the composite powder 100 of the embodiment, the PN junction between the N-type semiconductor particles 102 and the corresponding P-type semiconductor nano-particles 104 may be formed a built-in electric field. When the composite powder 100 absorbs light energy of the embodiment, electrons and/or electric holes in the PN junction are separated by the built-in electric field, so that the visible light-excited electrons and/or electric holes have a stronger reduction capability and oxidation capability to conduct a photocatalytic reaction. The improved oxidation capability of this photocatalyst is expected to have the anti-bacterial ability. In another aspect, when the P-type semiconductor nano-particles 104 are silver oxide nano-particles of the embodiment, silver ions dissolved out therefrom may be used for the anti-bacterial purpose, so that the composite powder 100 has an anti-bacterial ability in a dark room (i.e. without light irradiation) of the embodiment. Therefore, the composite powder 100 of the embodiment not only has an anti-bacterial ability without light irradiation, but the composite powder 100 has high photocatalytic ability and an excellent anti-bacterial ability under visible light irradiation due to the collaborative capability of the PN junction.

In order to improve reliability of the invention, the following lists several examples and several comparative examples to illustrate the composite powder 100 of the invention further. Although the following experiments are described, the material used and the amount and ratio of each thereof, as well as handling details and handling procedures, etc., can be suitably modified without exceeding the scope of the invention.

Accordingly, restrictive interpretation should not be made to the invention based on the embodiments described below.

First, a manufacturing method and an experimental method of Example 1 (the composite powder with a plurality of zinc oxide particles and a plurality of silver oxide nano-particles which is called for short as ZnO/Ag₂O composite powder hereinafter) is illustrated.

### EXAMPLE 1

### A Weight Ratio of ZnO and Ag₂O of the ZnO/Ag₂O Composite Powder is 1:0.1

First, 73.593 mg silver nitrate is dissolved in 1000 ml deionized water to Balm silver nitrate aqueous solution which is uniformly stirred for 30 minutes. Next, 500 mg zinc oxide powder is added thereto and stirred for 30 minutes, so that silver ions are uniformly distributed on surfaces of zinc oxide. Then, 34.63 mg, 100 ml sodium hydroxide aqueous solution is dropwise added thereto, and then washed by deionized water and alcohol with high purity respectively for three times after reaction for 30 minutes. The temperature of the thermostatic water bath of the reduced pressure concentrator is set at 60° C. to remove excess alcohol and water.

Photocatalytic Experiment

The ZnO/Ag2O composite powder of Example 1 is used as a photocatalyst. Methylene Blue (MB) is selected as a dye. A 150 watt halogen light tube is selected as light source to provide visible light source.

First, 20 mg ZnO/Ag₂O composite powder of Example 1 used as a catalyst is added into 100 ml prepared dye solution, and the decomposition experiment of visible light irradiation is conducted in 10 ppm dye solution. In the experiment, the catalyst is uniformly ultrasonic-vibrated and then is stirred in a dark room for 30 minutes in the dye solution. Then 5 ml dye solution is taken out. Next, the solution is placed and stirred on a magnet stirrer and irradiated with visible light. For the observation of changes in the dye concentration, 5 ml dye solution is taken out every 5-15 minutes until the dye is completely degraded or sustained for 30 minutes.

In the following, the manufacture and the experiment of the ZnO/Ag₂O composite powders of Example 2 to Example 5 and the powders of Comparative Examples 1-2 are conducted in similar methods described above.

### EXAMPLE 2

### A Weight Ratio of ZnO and Ag₂O of the ZnO/Ag₂O Composite Powder is 1:0.2

### EXAMPLE 3

### A Weight Ratio of ZnO and Ag₂O of the ZnO/Ag₂O Composite Powder is 1:0.3

### EXAMPLE 4

### A Weight Ratio of ZnO and Ag₂O of the ZnO/Ag₂O Composite Powder is 1:0.4.

### EXAMPLE 5

### A Weight Ratio of ZnO and Ag₂O of the ZnO/Ag₂O Composite Powder is 1:0.5.

### Comparative Example 1

### Only ZnO Powder

### Comparative Example 2

### Only Ag2O Powder

After that, results of the photocatalytic experiments of Examples 1-5 and Comparative Examples 1-2 are plotted to obtain a dye decomposition ratio along with time, wherein the horizontal axis is time (minute), and the vertical axis is the dye decomposition ratio (residue concentration/original concentration represented by C/Co).

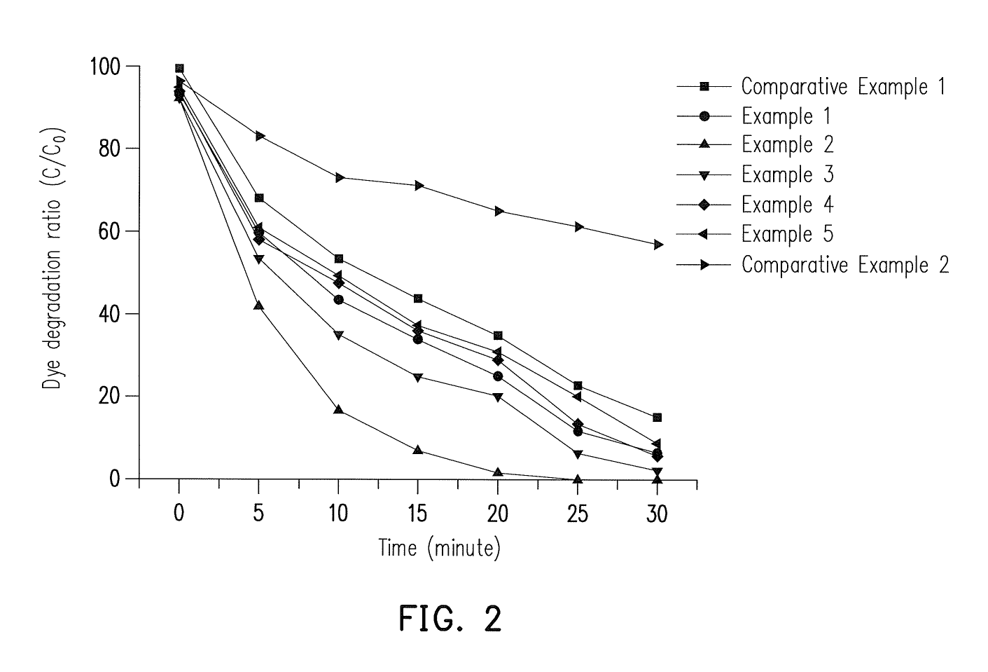

FIG. 2 is a curve diagram illustrating a dye decomposition ratio versus time of the composite powders of Examples 1-5 and Comparative Examples 1-2 under visible light irradiation.

As shown in FIG. 2, the photocatalytic reactions of visible light of the ZnO powder and the Ag₂O powder (Comparative Examples 1-2) are not ideal. The dye decomposition ability of the ZnO/Ag₂O composite powders (Examples 1-5) is improved much so as to proof that the ZnO/Ag₂O composite powder has a better photocatalytic ability compared to the pure ZnO powder and the pure Ag₂O powder (Comparative Examples 1-2). In Examples 1-5, the ZnO/Ag₂O composite powder with a weight ratio of ZnO and Ag₂O being 1:0.2 (Example 2) has the fastest dye decomposition rate, and has the best photocatalytic ability.

Following the results of the photocatalytic experiment, the ZnO/Ag₂O composite powder of Example 2 having the best photocatalytic ability of the invention is used to conduct the anti-bacterial experiment of E. Coli.

Anti-Bacterial Experiment

First, the required Luria-Bertani broth (LB broth) and LB agar are prepared. The LB broth is the required nutrient solution mainly for bacterial growth while the LB agar is used as the last bacterial plating count to clearly observe the growing number of bacteria. The detailed experimental procedures are as follows. First, the LB in the liquid state is sterilized under high temperature and high pressure for 20 minutes. The sterilization process can remove the microorganism attached on the broth and the agar. The LB in the above-mentioned liquid state is to dissolve Tryptone and Yest extract into pure water. The LB agar is formed by adding agar in the liquid LB, sterilizing in the sterilizing compartment, and then pouring the LB agar into a dish in fixed-size to form the gel which is stored in the refrigerator cold room at 4° C.

When preparation of the strain liquid, E. Coli strain liquid which is continuously stirred and prepared the day before taken out is added into the LB broth in a ratio of 1:100 to amplify. The purpose thereof is to dilute and activate the E. Coli strain liquid. Then, 1 ml of the LB broth (without E. Coli) and 1 ml of the diluted E. Coli strain liquid are taken out respectively and dropped into different quartz tubes. A concentration of the strain liquid is measured by a biochemical analysis spectrometer. An optical density (OD; 1OD=6×10⁷ CFU; CFU is Colony-Forming Units) of the diluted E. Coli strain liquid is measured by using 595 nm wavelength while the LB broth (without E. Coli) is used as a background value. After the measurement, 1 OD strain liquid is adjusted to a concentration of 8.2×10⁸ CFU by the LB broth.

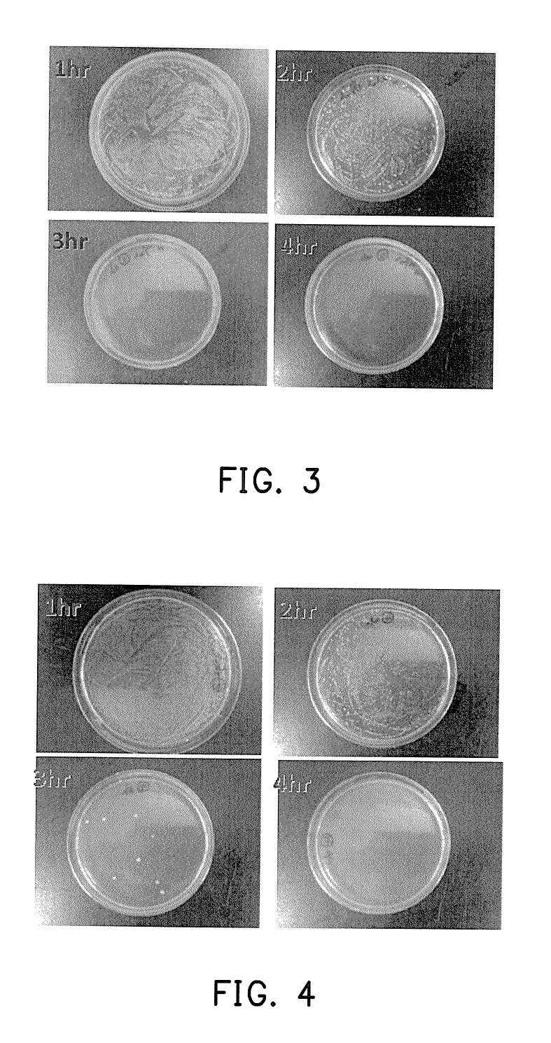

5 mg ZnO/Ag₂O composite powder is uniformly mixed with the adjusted E. Coli strain liquid to form a mixed solution. Then, 1 ml mixed solution is taken out and placed in a 1.5 ml capacity plastic vial. The plastic vial with E. Coli strain liquid is placed under 20W LED light source (i.e. under visible light irradiation; the experimental results thereof as shown in FIG. 3) or wrapped with aluminum foil (i.e. in a dark room; the experimental results thereof as shown in FIG. 4). 0.1 ml E. Coli strain liquid is respectively taken out and dropped on the LB agar dish every 1 hour, uniformly coated, and dried. The coated LB agar dish is placed upside down in an oven at 37° C. more than 8 hours. After that, the LB agar dish is taken out from the oven and the bacterial colonies on the LB agar dish are calculated.

### EXAMPLE 6

Example 6 is used the ZnO/Ag₂O composite powder of Example 2 (i.e. a weight ratio of ZnO and Ag₂O is 1:0.2) mixing uniformly with the adjusted 1 ml E. Coli strain liquid to form a mixed solution (which is called for short as ZnO/Ag₂O mixed solution hereinafter). Next, under visible light irradiation, the ZnO/Ag₂O mixed solution of Example 6 is used to conduct the above-mentioned anti-bacterial experiment.

### EXAMPLE 7

Example 7 is used the ZnO/Ag₂O mixed solution of Example 6 to conduct the above-mentioned anti-bacterial experiment in a dark room.

FIG. 3 is a picture illustrating a LB agar of the ZnO/Ag₂O mixed solution with E. coli of Example 6 after different irradiation times of visible light. FIG. 4 is a picture illustrating a LB agar of the ZnO/Ag₂O mixed solution with E. coli of Example 7 in a dark room in different times.

From FIG. 3, E. Coli in the LB agar with the ZnO/Ag₂O mixed solution of Example 6 is decreased gradually until disappear completely under visible light irradiation in 1-3 hours. From FIG. 4, E. Coli in the LB agar with the ZnO/Ag₂O mixed solution of Example 7 is decreased gradually until disappear completely in a dark room without light irradiation in 1-4 hours. From the results, with the ZnO/Ag₂O composite powder not only has a high photocatalytic characteristic and an anti-bacterial ability under visible light irradiation, but also has an anti-bacterial ability without light irradiation.

Composite thin Film Technology

In addition, the composite powder 100 of the embodiment maybe exist in a powder form and a thin film form. The following will illustrate the manufacturing method of the composite thin film.

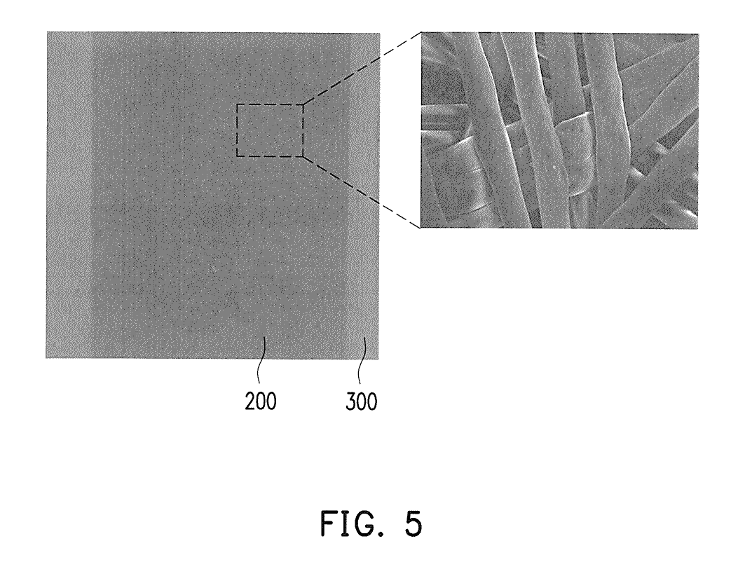

FIG. 5 is a picture illustrating the ZnO/Ag₂O composite thin film coated on fabrics.

In the embodiment, the composite powder 100 may be formed a composite thin film on a surface of a substrate by a sputtering process. For example, the forming procedures of the composite thin film are as follows. First, the composite powder 100 with a composition of Example 3 is placed in a graphite mold, and then is heated and pressed at 180° C. for 30 minutes under argon environment so as to form a 2-inch target. After that, the target is placed in a RF magnetron sputter to conduct physical vacuum sputtering thin film, so that the composite thin film 200 is sputtered on fabrics 300. As shown in FIG. 5, the composite thin film 200 of the embodiment uniformly and completely covers the surface of the substrate (i.e. fabrics) 300. In an embodiment, the substrate 300 may be a filter, fabrics, non-fabrics, a plastic material, glass, tiles, a metallic material, a biomedical material, or a variety of substrates which need to have a photocatalytic characteristic and an anti-bacterial ability simultaneously. The scope of the application of the composite thin film 200 is not limited to the invention. In an embodiment, the sputtering process may be a RF magnetron sputtering coating process, for example.

The anti-bacterial experiment for composite thin films is the same as Example 6 except that a diluted E. Coli strain liquid of 10⁴ CFU by the LB broth is used to mix with the ZnO/Ag₂O-coated nonwoven fabrics.

### EXAMPLE 8

Example 8 is used the ZnO/Ag₂O composite film, sputtered with a target of Example 3 on fabrics, to cut into the dimensions of 2 (length)×1.5 (width) cm² and mix with the 1 ml diluted E. Coli strain liquid. After LED visible light irradiation for 1-3 hours, 0.1 ml strain liquid is taken out at each stage and uniformly coated on the LB agar dish. After the dish is placed in an incubator for 7 hours, the dish is taken out and the numbers of bacterial colonies are observed.

### EXAMPLE 9

Example 9 is used the composite film of Example 8 to conduct the above-mentioned anti-bacterial experiment in a dark room.

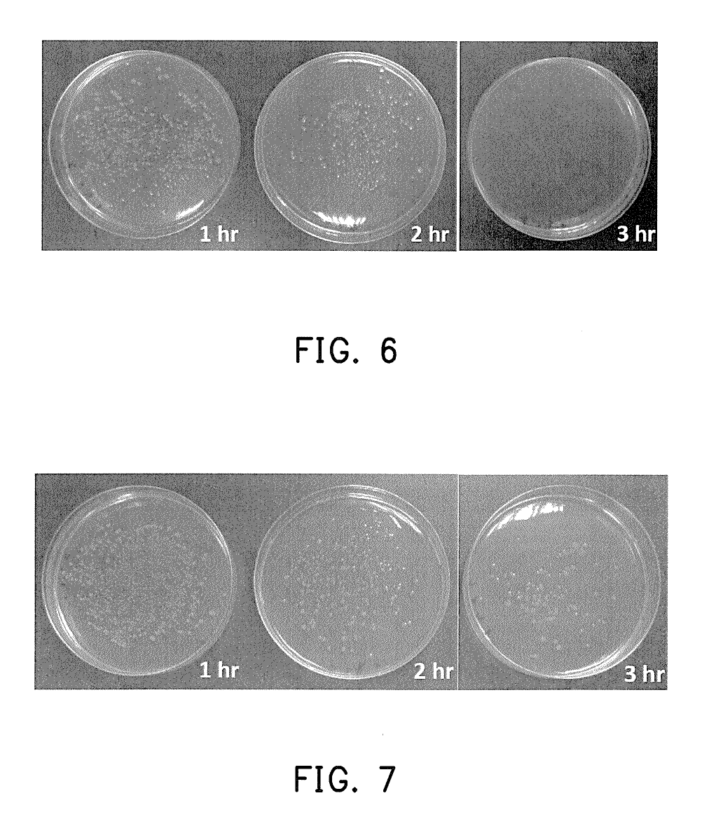

FIG. 6 is a picture illustrating a LB agar of the composite film with E. coli of Example 8 under visible light irradiation in different times. FIG. 7 is a picture illustrating a LB agar of the composite film with E. coli of Example 9 in a dark room in different times.

From FIG. 6, E. Coli on the composite film of Example 8 is decreased gradually until disappear completely under visible light irradiation in 3 hours. From FIG. 7, E. Coli on the composite film of Example 9 is decreased gradually in a dark room without light irradiation in 1-3 hours. From the results, the composite film formed from the mixture of the ZnO/Ag₂O composite powder has a high photocatalytic characteristic and a very good anti-bacterial ability under visible light irradiation. Although the anti-bacterial ability of the composite film of Example 9 without light irradiation is weaker than under visible light irradiation, the numbers of E. Coli are decreased after a period of time.

Besides, the composite powder 100 may be used alone and used with other polymer materials together to increase the scope of the application. In specific, the invention provides a hybrid material including polymer materials and the composite powder 100 of the embodiment, wherein the composite powder 100 is uniformly mixed with the polymer materials. The polymer materials include thermoplastic resin materials, such as nylon, polyethylene, polypropylene, polyester, and the like, thermosetting resin materials, such as epoxy resin, polyurethane, and the like, or a combination thereof.

In an embodiment, the hybrid material of the embodiment may cover the surface of the substrate or mix within the substrate. The substrate may be, such as a filter, fabrics, non-fabrics, a plastic material, glass, tiles, a metallic material, a biomedical material, paint, or a variety of substrates which need to have a photocatalytic characteristic and an anti-bacterial ability simultaneously. The scope of the application of the hybrid material is not limited to the invention.

Organic/Inorganic Hybrid Composite Material Technology

A hybrid material of 40 wt % ZnO/Ag₂O composite powder and 60 wt % nylon (Elvamide® Nylon 8061) is used as an example to illustrate. First, 860 mg nylon particles (Elvamide® Nylon 8061) are dissolved in 50 ml anhydrous ethanol, and then are heated to 80° C. by a heating plate and agitated by a magnet stirrer for 2 hours to prepare a nylon solution A. Next, the pre-weighed 80 mg ZnO/Ag₂O composite powder is added into anhydrous ethanol respectively to prepare a solution B. The solution B is added into the nylon solution A according to the desired proportion, so that a total weight of the polymer and the inorganic powder is fixed in 200 mg, and then ultrasonic-vibrated for 3 hours to form a Nylon-ZnO/Ag₂O coating solution. After that, the coating solution is poured in culture dishes, and the prepared nonwoven fabrics are immersed in the designate dishes respectively and ultrasonic-vibrated for 15 minutes. At this time, the nonwoven fabrics are covered by the Nylon-ZnO/Ag₂O coating solution, and then taken out and placed in a fume hood. After drying the nonwoven fabrics for 12 hours, the nonwoven fabrics covering the Nylon-ZnO/Ag₂O hybrid film are formed.

### EXAMPLE 10

Example 10 is used the Nylon-ZnO/Ag₂O hybrid film to cut into the dimensions of 2 (length)×1.5 (width) cm² and mix with the 1 ml diluted E. Coli strain liquid as applied for Example 8. After LED visible light irradiation for 1-3 hours, 0.1 ml strain liquid is taken out at each stage and uniformly coated on the LB agar dish. After the dish is placed in an incubator for 7 hours, the dish is taken out and the numbers of bacterial colonies are observed.

### EXAMPLE 11

Example 11 is used the hybrid film of Example 10 to conduct the above-mentioned anti-bacterial experiment in a dark room.

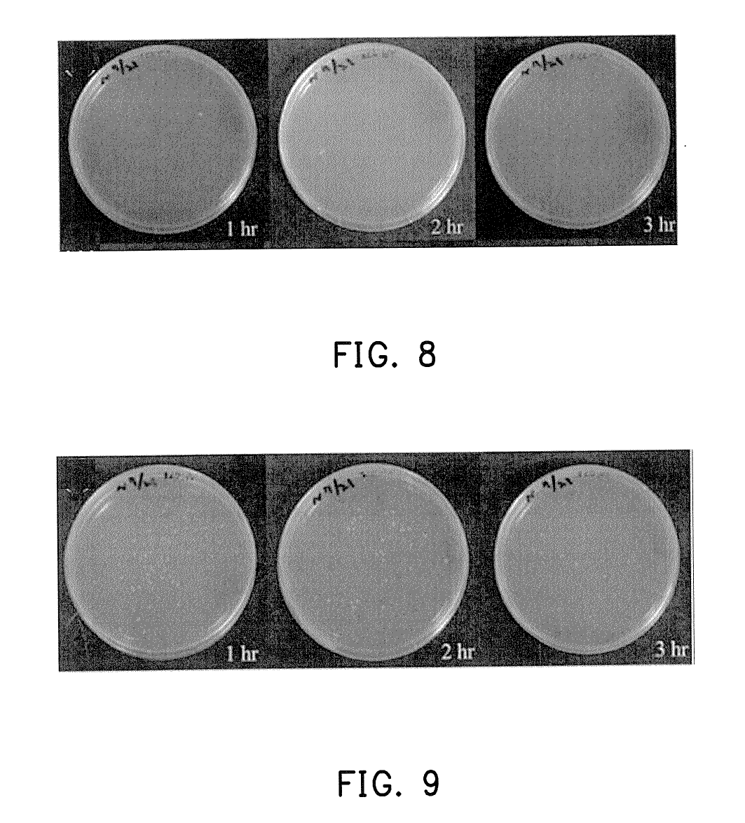

FIG. 8 is a picture illustrating a LB agar of the hybrid film solution with E. coli of Example 10 under visible light irradiation in different times. FIG. 9 is a picture illustrating a LB agar of the hybrid film solution with E. coli of Example 11 in a dark room in different times.

From FIG. 8, E. Coli in the hybrid film of Example 10 is decreased gradually until disappear completely under visible light irradiation in 1-2 hours. From FIG. 9, E. Coli in the hybrid film of Example 11 is decreased gradually in a dark room without light irradiation in 1-3 hours. From the results, the hybrid film formed from the mixture of the ZnO/Ag₂O composite powder and the polymer materials has a high photocatalytic characteristic and a very good anti-bacterial ability under visible light irradiation. Although the anti-bacterial ability of the hybrid film of Example 11 without light irradiation is weaker than under visible light irradiation, the numbers of E. Coli are decreased after a period of time.

In addition, the embodiment also includes a composite powder used for the purpose of degradation of a surrogate of chemical warfare agents. The composite powder includes a plurality of support particles of alumina or zinc oxide and a plurality of silver oxide nano-particles. The silver oxide nano-particles uniformly and discontinuously cover surfaces of the support particles. In an embodiment, a weight ratio of the support particles and the silver oxide nano-particles covers a range from a low silver oxide ratio of 1:0.01 increasingly to pure silver oxide. The surrogate may be 2-chloroethyl ethyl sulfide, for example.

Toxic Chemical Elimination Experiment

Ag₂O/Al₂O₃ Composite Powder

First, an isopropanol solution with a concentration of 0.35% and a volume of 50 ml 2-chloroethyl ethyl sulfide (C₂H₅SCH₂CH₂Cl, 2-CEES) is prepared. Next, the isopropanol solution with 2-CEES is added into 50 mg Ag₂O/Al₂O₃ composite powder and quickly stirred, and then is separated into 3 batches to react for 15, 30, and 60 minutes respectively under the fluorescent room lamp. After the reaction, 1 ml isopropanol is added therein respectively to terminate the reaction. The terminated reaction solution is separated by a centrifugal machine, and the reactants are identified by a GC-MS (Perkin Elmer Clarus 600T, Turku, Finland) mass spectrometer.

In the following, experiments of the composite powders of Examples 12-13 and Comparative Examples 3-4 are conducted in similar methods described above.

### EXAMPLE 12

### Ag₂O/Al₂O₃ Composite Powder

### EXAMPLE 13

### Ag₂O/0.5 wt % Na₂SiO₃/Al₂O₃ Composite Powder

### Comparative Example 3

### Ag/Al₂O₃ Composite Powder

### Comparative Example 4

### Ag/0.5 wt % Na₂SiO₃/Al₂O₃ Composite Powder

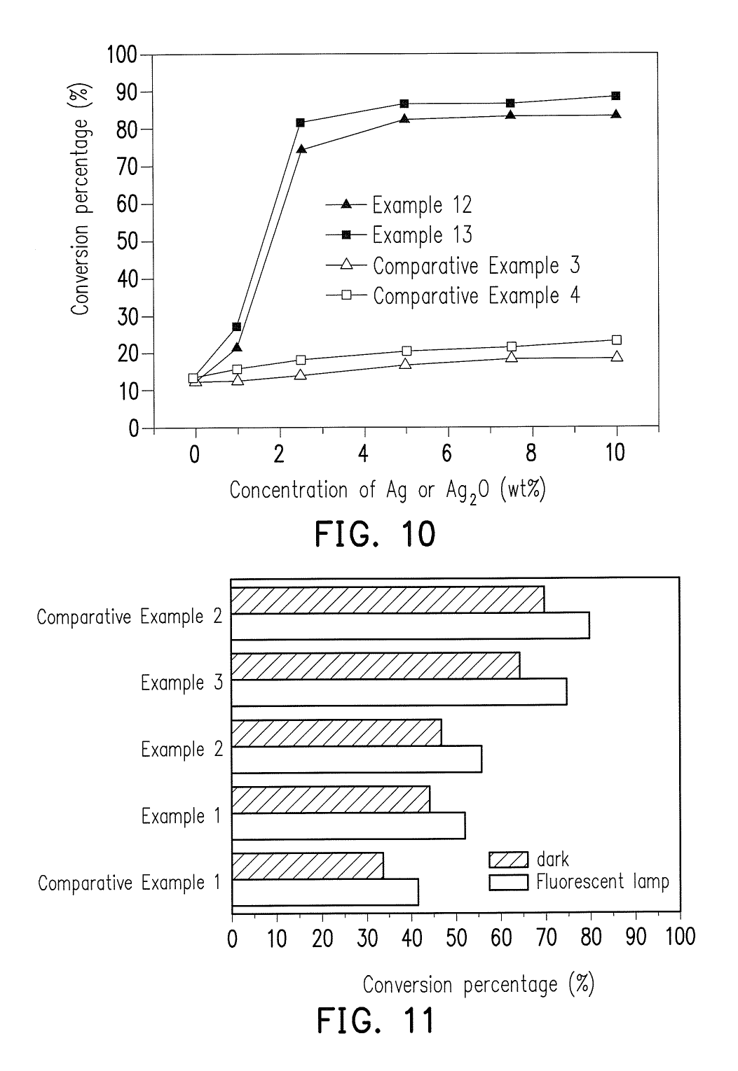

FIG. 10 is a view illustrating a concentration of Ag or Ag₂O of the composite powder versus a conversion percentage of the toxic chemical of 2-CEES of Examples 12-13 and Comparative Examples 3-4 in 15 minutes.

As shown in FIG. 10, the degradation rates of the Ag/Al₂O₃ composite powder and Ag/0.5 wt %Na₂SiO₃/Al₂O₃ composite powder (Comparative Examples 3-4) to the toxic chemical of 2-CEES are not ideal in 15 minutes. However, the Ag₂O/Al₂O₃ composite powder and the Ag₂O/0.5 wt %Na₂SiO₃/Al₂O₃ composite powder (Examples 12-13) can degrade the toxic chemical of 2-CEES more than 80% in 15 minutes compared to Comparative Examples 3-4, and the toxic chemical of 2-CEES is degraded to 2-(ethylthio)ethanol and 2-(ethylthio)ethanoic acid without toxicity. In addition, the toxic chemical of 2-CEES may be degraded completely by the Ag₂O/Al₂O₃ composite powder of Examples 12-13 after 30 minutes. From this, the Ag₂O/Al₂O₃ composite powder of the embodiment may effectively and completely degrade the toxic chemical of 2-CEES to a harmless material for human in 15 minutes to 30 minutes. Therefore, the embodiment with the Ag2O composite powder may be applied in a canister, a mouth mask, and chemical pollutants, so that a threat of chemical war is reduced.

ZnO/Ag₂O

In the following, toxic chemical elimination experiments of the composite powders of Examples 1-3 and Comparative Examples 1-2 are conducted in similar methods described above, except the dark test condition is also included.

FIG. 11 is a view illustrating a concentration of Ag₂O of the composite powder versus a conversion percentage of the toxic chemical of 2-CEES of Examples 1-3 and Comparative Examples 1-2 in 15 minutes under fluorescent room lamp and in a dark condition.

As shown in FIG. 11, the degradation rates under the fluorescent room lamp is slightly faster than those in a dark condition. The degradation rate also slightly increases with the increase in the Ag₂O content. The ZnO/Ag₂O composite powder of Example 3 can degrade the toxic chemical of 2-CEES about 75% in 15 minutes, comparable to the 80% degradation for using pure Ag₂O of comparative example 2.

In summary, in the composite material (including powders or thin films) of the invention, the N-type ZnO semiconductor particles in sub-micrometer size are covered with the P-type Ag₂O semiconductor nano-particles in nanometer size to form the composite material with the PN junction. Thus, the ZnO/Ag₂O composite material of the invention has an anti-bacterial ability without light irradiation, while the ZnO/Ag₂O composite material of the invention has a high photocatalytic ability and an advanced anti-bacterial ability under visible light irradiation. Therefore, the ZnO/Ag₂O composite material of the invention may be applied in a variety of substrates to avoid vectors breeding. At the same time, the harmful organic substance in air may be continuously absorbed and degraded to achieve the effect of air purification.

In addition, the composite material of the invention may be mixed with the polymer material to form the hybrid material which has a photocatalytic characteristic and an anti-bacterial ability simultaneously. Besides, the invention also provides the Ag₂O/Al₂O₃ and ZnO/Ag₂O composite powders used for the purpose of degradation of a surrogate of chemical warfare agents, so that a threat of chemical war is reduced.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A composite powder used for the visible light catalytic and anti-bacterial purposes, comprising:
a plurality of N-type semiconductor particles; and
a plurality of P-type semiconductor nano-particles covering surfaces of the N-type semiconductor particles respectively, and a weight ratio of the N-type semiconductor particles and the P-type semiconductor nano-particles is in a range of 1:0.1 to 1:0.5, wherein
a PN junction is provided between each of the N-type semiconductor particles and the corresponding P-type semiconductor nano-particles.

2. The composite powder according to claim 1, wherein a material of the N-type semiconductor particles comprises zinc oxide, and a material of the P-type semiconductor nano-particles comprises silver oxide.

3. The composite powder according to claim 1, wherein a particle size of the N-type semiconductor particles is in a range of 0.1 μm to 5 μm, and a particle size of the P-type semiconductor nano-particles is in a range of 1 nm to 50 nm.

4. The composite powder according to claim 1, wherein the P-type semiconductor nano-particles are uniformly distributed on the surfaces of the N-type semiconductor particles.

5. A composite thin film used for the visible light catalytic and anti-bacterial purposes, comprising:
the composite powder according to claim 1, wherein the composite thin film is formed on surfaces of a substrate from the composite powder by a sputtering coating process.

6. A hybrid material used for the visible light catalytic and anti-bacterial purposes, comprising:
a polymer material; and
the composite powder according to claim 1, wherein the composite powder is uniformly mixed with the polymer material.

7. The hybrid material according to claim 6, wherein the hybrid material covers a surface of a substrate or mixes within the substrate.

8. The hybrid material according to claim 6, wherein the polymer material comprises a thermoplastic resin material, a thermosetting resin material, or a combination thereof.

9. A composite powder used for the purpose of degradation of a surrogate of chemical warfare agents, comprising:
a plurality of support particles; and
a plurality of silver oxide nano-particles covering surfaces of the support particles respectively, and a weight ratio of the support particles and the silver oxide nano-particles covers a range from a low silver oxide ratio of 1:0.01 increasingly to pure silver oxide.

10. The composite powder according to claim 9, wherein the surrogate comprises 2-chloroethyl ethyl sulfide and the support particles comprises un-modified and modified Al₂O₃ and ZnO.
